(19) United States
(12) Patent Application Publication
(10) Pub. No.: US 2016/0274569 A1
(43) Pub. Date: Sep. 22, 2016

(54) SCALABLE MANUFACTURING SYSTEM AND METHOD FOR IMPLEMENTING THE SAME

(71) Applicant: ARCADYAN TECHNOLOGY CORPORATION, Hsinchu City (TW)

(72) Inventor: Chin-Hsin Peng, HSINCHU CITY (TW)

(21) Appl. No.: 14/845,664

(22) Filed: Sep. 4, 2015

Related U.S. Application Data
(60) Provisional application No. 62/133,599, filed on Mar. 16, 2015.

(51) Int. Cl. G05B 19/406; G05B 15/02

(52) U.S. Cl. CPC G05B 19/406; G05B 15/02; G05B 2219/32423

(57) ABSTRACT

The disclosure is related to a scalable manufacturing system and a method for implementing the same. The scalable manufacturing system incorporates one or more standardized solid manufacture units to form a manufacture module. To replace at least one site of the traditional production line, the manufacture module performs a specific function over a production line. Multiple manufacture modules are assembled by means of stacking vertically and in a left-to-right arrangement, so as to form a manufacture frame. The manufacture frame is utilized to perform a specific production process. Multiple manufacture frames form a manufacture unit for performing a more complex process. Therefore a 3D production line is established. A transportation means is also introduced in between the manufacture cells. A high-performance scalable manufacturing system is achieved efficiently using space.

### BACKGROUND OF THE INVENTION

1. Field of the Invention

The present invention is generally related to a manufacturing system and a method thereof, in particular, to a scalable manufacturing system which is able to expand the function modules, and a method for implementing the system.

2. Description of Related Art

The conventional production line adopts a full line of a transmission band rollers, or a kind of two-dimensional transportation. The production line is configured to fit in with the production function for every site. For example, a robot arm or any other function module may be introduced into the production line for a specific target of production. Even though the robot or robot arm is employed, the transmission band rollers are still a requisite tool for transportation. Not only does the conventional production line require a large factory space, but also costs are high if the production line is reconfigured when the production facilities are modified when changing the production line.

For reducing cost of time for modifying the production facilities, a modularized production line is introduced in a conventional technology. Various functions provided over the production line are implemented by means of modular machines or tools. The modules for the production line are flexibly designed for achieving a specific target of production.

### SUMMARY OF THE INVENTION

The disclosure is related to a scalable manufacturing system, in particular to a technology for rendering a production line through standardized and modular manufacture cell(s). The manufacturing system is able to fit in with production demand flexibly, and also use the space effectively with high efficient production. In the scalable manufacturing system, a fundamental and standardized manufacture unit defines a fundamental space, and a manufacture module is configured to perform a specific function for the system according to a production demand. With assembly of the modules, a three-dimensional production line is established.

In one embodiment, the scalable manufacturing system is configured to have one or more manufacture cells according to a production demand. Every manufacture cell may have one or more manufacture frames. One manufacture frame may achieve one production line. Every manufacture frame can be formed by assembling one or more manufacture modules in the production process based on a production demand. The manufacture module performs one function in the production process. The manufacture module is formed of one or more manufacture units that defines the fundamental space.

The scalable manufacturing system has a control device, which is electrically connected with every manufacture cell, is used to control the production process among the manufacture cells. The control device is electrically connected with every manufacture frame and controls the production process among the multiple manufacture frames. Still further, the manufacture module is controlled by the control device for performing a specific function.

In one further embodiment, the manufacturing system includes multiple manufacture cells, and one or more operating sets are disposed among the manufacture cells. If there are multiple manufacture frames required for a production process, the one or more operating sets may be disposed among the manufacture frames.

To embody the scalable manufacturing system, using a computer system, a production demand for the manufacturing system is created. While analyzing the production demand, the requirement of one or more manufacture cells is obtained. While analyzing the manufacture cell, one or more manufacture frames may be required. The one or more manufacture frames forms a manufacture cell. While analyzing the manufacture frame, the requirement of one or more manufacture modules is obtained. Every manufacture module performs one function for the production demand. Further, more manufacture units may be obtained by analyzing every manufacture module.

### BRIEF DESCRIPTION OF THE DRAWINGS

FIG. 1A shows a schematic diagram depicting a manufacture unit in a scalable manufacturing system in one embodiment in accordance with the present invention;

FIG. 1B shows a schematic diagram depicting a manufacture module in the scalable manufacturing system of the present invention;

FIG. 1C shows a schematic diagram depicting a manufacture frame in the scalable manufacturing system according to one embodiment of the present invention;

FIG. 1D shows a schematic diagram depicting a manufacture cell in the scalable manufacturing system in one embodiment of the present invention;

FIG. 2 schematically shows a structure depicting the scalable manufacturing system;

FIG. 3 shows a schematic diagram depicting the scalable manufacturing system in one embodiment of the present invention;

FIG. 4 shows one more schematic diagram depicting the scalable manufacturing system in one embodiment of the present invention;

FIG. 5 shows a schematic diagram describing the scalable manufacturing system in one embodiment of the present invention;

FIG. 6 shows the function modules for the scalable manufacturing system in one embodiment of the present invention;

FIG. 7 shows a flow chart describing the method for implementing the scalable manufacturing system according to one embodiment of the present invention;

FIGS. 8 through 11 schematically show the various types of the scalable manufacturing system.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

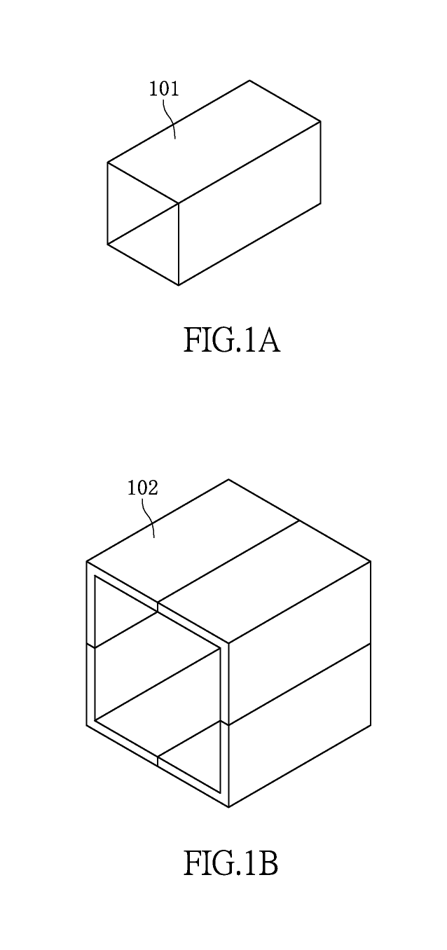

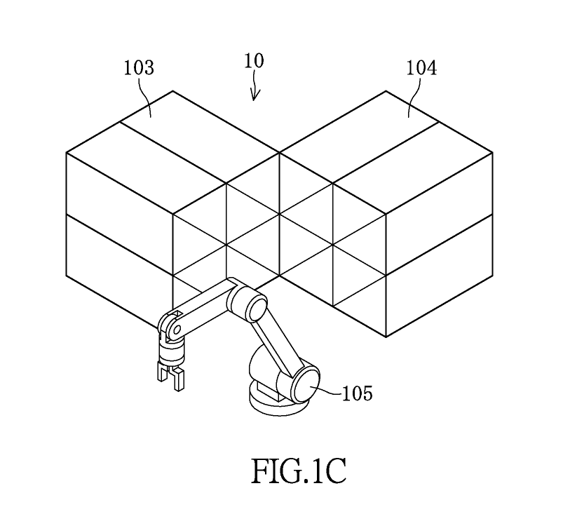

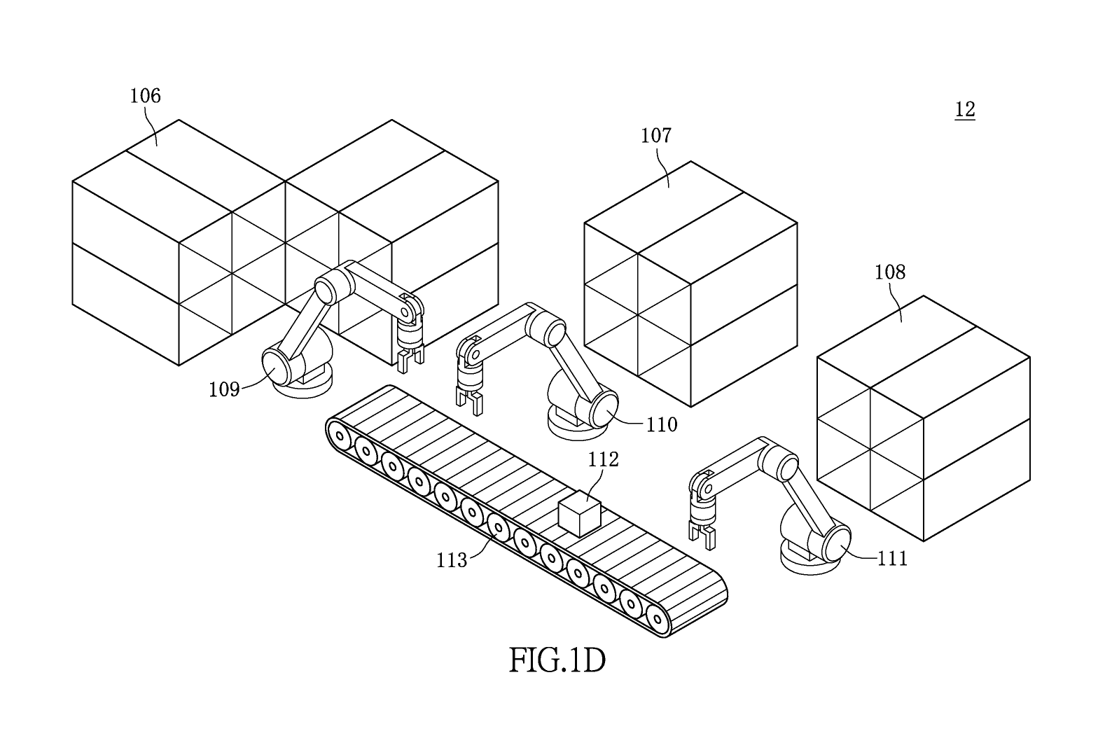

The disclosure is related to a scalable manufacturing system in accordance with the present invention. In an exemplary example, the manufacturing system is based on one or more standardized solid manufacture units. One manufacture unit defines a fundamental unit for the manufacturing system. The manufacturing system implements an automatic and flexible production line. With reference to FIG. 1, a schematic diagram is shown to depict the manufacture unit for the scalable manufacturing system in accordance with the present invention. For example, a manufacture unit 101 is described.

One of the objectives of the manufacture unit 101 is to define a fundamental space. For example, the manufacture unit may occupy a basic geometry of space such as a cube or a cuboid that forms the minimum space unit for the manufacturing system. The manufacture unit 101 may have a fixed size specified by a length, a width and a height. Multiple manufacture units 101 may form a manufacture module, a manufacture frame, or expand to a manufacture cell. The manufacture module, the manufacture frame, or the manufacture cell individually forms the fundamental component of the whole manufacturing system. The system is therefore established by assembling the multiple manufacture units 101 since every manufacture unit 101 has fixed size. Since each manufacture unit 101 is with standardized size, it is convenient for a robot arm to operate positioning over the manufacturing system, which is made of the standardized units. Further, article transportation between the manufacture modules can be easily positioned. Furthermore, once any new function has been developed, the corresponding module may be designed based on the standardized size. Then, it is very easy to dispose the function to the manufacturing system.

Next, based on target of production, one or more manufacture units are configured to form a manufacture module. Reference is made to FIG. 1B depicting a schematic diagram of the manufacture module of the scalable manufacturing system.

In the current example, the manufacture module 102 is made of four (two-by-two) manufacture units (101, FIG. 1). The manufacture module 102 is configured to occupy a space specified in a production line for performing a corresponding function. The target of production suggests the space which is defined by a number of the manufacture units. Then the manufacture module 102 is configured to render at least one function, and achieve one step of the manufacturing process. One of the objectives of the manufacture module is to substitute at least one site of the traditional production line.

Further, for a specific target, the manufacturing system is configured to have at least one manufacture frame for achieving a complete production line. The manufacture frame may be made by one manufacture module, or multiple manufacture modules which are based on stacking vertically and/or left-to-right arrangement for a specific destination. The related reference is to FIG. 1C.

In FIG. 1C, a manufacture frame 10 is exemplarily assembled by two manufacture modules 103 and 104. The manufacture frame 10 is therefore able to operate at least two steps of the manufacturing process, and used to substitute two sites of the traditional production line. In addition, if more integrated functions rendered by more manufacture modules (103, 104) are incorporated to this manufacture frame 10, the single manufacture frame 10 may be enough to achieve one single product production line. This shows that the single manufacture frame 10 can usefully achieve one production line.

The formation and arrangement of the manufacture modules (103, 104) are not limited to the diagrams shown in the figures. The configuration of the manufacturing system can flexibly fit in with an actual manufacturing plant, or any requirement of an actual manufacturing process. For example, the manufacture modules may be arranged stacked vertically due to the limitation of space. In an exemplary example, when the two manufacture module 103, 104 are respectively operated for two manufacturing functions, an operating set 105 may be incorporated in between the manufacture modules 103, 104. The products made by the two different manufacture modules 103, 104 may be exchanged via the operating set 105. The operating set 105 is such as a robot arm. The robot arm is used to transport the products between the manufacture modules 103 and 104. However, the traditional transmission band production roller or manpower may not be excluded in the production line.

In accordance with the present invention, the manufacture unit has standardized size and defines a fundamental unit for the manufacturing system. One or more manufacture units form a manufacture module so as to operate at least one function. Assembly of multiple manufacture modules may form a three-dimensional manufacture frame which is used to achieve a full or part of a production line or production process. However, the manufacturing system may further combine one or more manufacture frames to complete a full production line when only one manufacture frame fails to completely achieve the production line needed for a specific process. It is noted that the assembly of the multiple manufacture frames forms a manufacture cell. The manufacture cell is schematically described in FIG. 1D.

According to the schematic diagram shown in FIG. 1D, a manufacture cell 12 exemplarily forms a bigger scale of manufacturing system and may achieve a more complicated production process. For its production target, the manufacture cell 12 requires multiple manufacture frames 106, 107, 108. The manufacture cell 12 may be established by assembling multiple manufacture frames.

The example shows the manufacture frames 106, 107 and 108 are arranged at different locations of a plant. Each of the manufacture frames 106, 107 and 108 conducts different or the same manufacturing steps. Through more installations of the manufacture frames, the production can be doubled, or achieve even more complicated production demand.

For transmitting an article, one or more operating sets 109, 110 and 111 may be disposed between the manufacture frames 106, 107, 108. For transmitting an article, the operating set 109 associated with the manufacture frame 106 is cooperated with the operating set 110 of the manufacture frame 107. Further, the operating set 111 for the manufacture frame 108 is also interactive with the others. The operating sets 109, 110, and 111 are such as transportation devices, e.g. a robot arm, capable of moving rotatably and vertically, and with multi-angle displacement. The operating sets 109, 110, and 111 operate for their respective manufacture frames 106, 107, and 108, in addition to conducting transportation between an adjacent two of the manufacture frames 106, 107, and 108. In an example shown in the diagram, a transportation band 113 is introduced to link the operating sets 109, 110, and 111 for transmitting the article 112.

The above embodiment exemplarily shows the manufacture cell 12 combining the manufacture frames 106, 107, and 108 established for rendering a production line.

If the single manufacture cell is not able to take over a full production line, under the aspect of the scalable manufacturing system of the present invention, the system may incorporate more than one manufacture cell. At least one robot arm capable of moving in three-dimensional space is utilized in the system for transmitting the article among the manufacture cells. The transportation may also be made by other traditional ways. The transportation means allows the manufacturing system to combine multiple manufacture cells for a specific production target.

The transportation device such as a robot arm capable of moving rotatably and vertically, and with multi-angle displacement may be incorporated among the manufacture cells, or among the manufacture frames. Rather than the traditional transportation band, the robot arm is preferably used to move the article among the different manufacture modules for performing the respective functions.

From the above description, a specific link is introduced between the manufacture cells, e.g. a robot arm, a transmission band, or a transportation device such as a vehicle, so as to transmit the article between the cells. The mentioned specific link may also be a manufacture module, such as an input-output module (I/O module) in one aspect of the present invention.

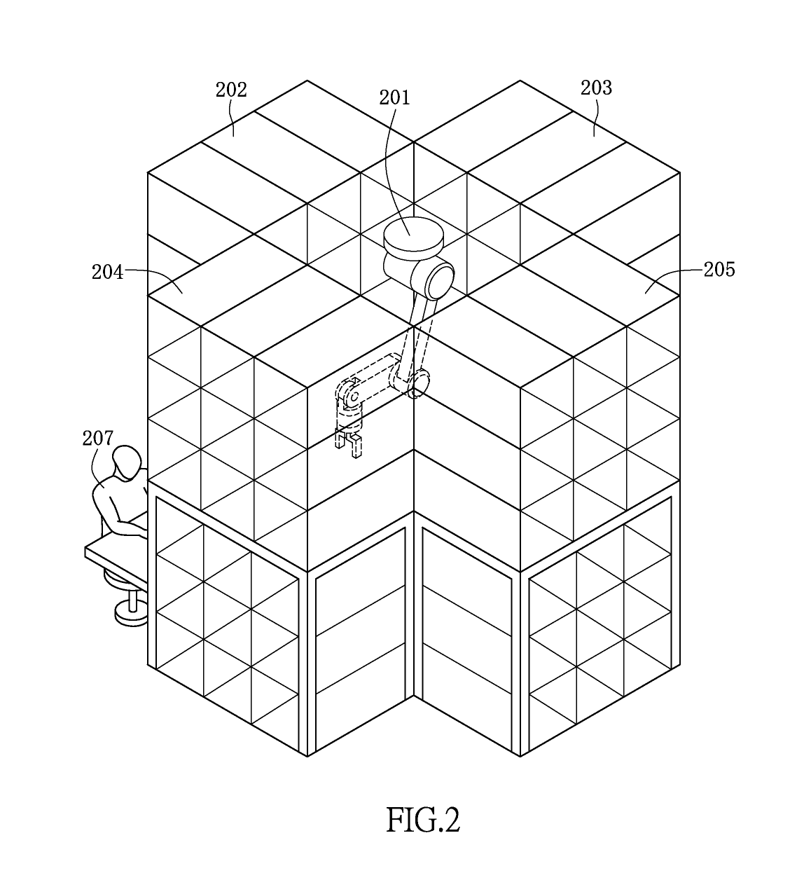

Reference is made to FIG. 2 depicting a schematic diagram of the scalable manufacturing system in one embodiment of the present invention.

A production line specified to a production demand is described. The production line is formed by a manufacture cell including multiple manufacture frames 202, 203, 204, and 205. The manufacture frames 202, 203, 204, and 205 are separately located at four sides in a space. The manufacture frames 202, 203, 204, and 205 are exemplarily surrounded to form a close production line. An operating set 201 is disposed in the central space, such as a robot arm capable of moving rotatably and vertically, and with multi-angle displacement.

Because the manufacture cell is formed by assembling the fundamental units which are standardized sizes, the whole manufacturing system is configured to be regulated under this standard. Therefore the system is flexible for every production demand. Even an operator 207 for the whole system can have his own space defined by the standardized units as a manufacture module in the manufacturing system under the aspect of invention. The manufacture module is provided for the operator 207 working within the manufacture frame 204.

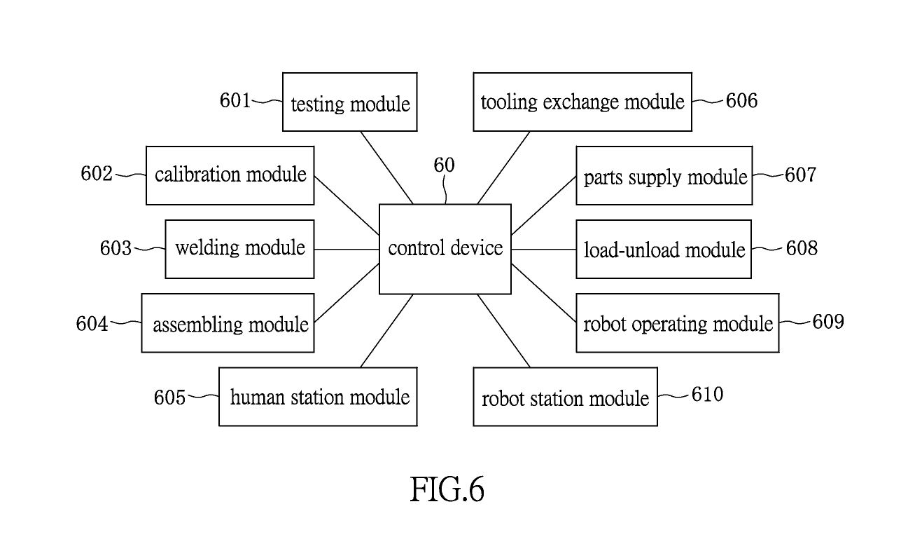

A robot arm is also provided in the system in the central predefined space. The robot arm may work among the manufacture modules having respective functions. Every manufacture module is designed according to the practical production demand. The functions made by the manufacture modules may be referred to in the description in FIG. 6, for example testing module (601), calibration module (602), welding module (603), assembling module (604), human station module (605), tooling exchange module (606), parts supply module (607), load-unload module (608), robot operating module (609), and robot station module (610).

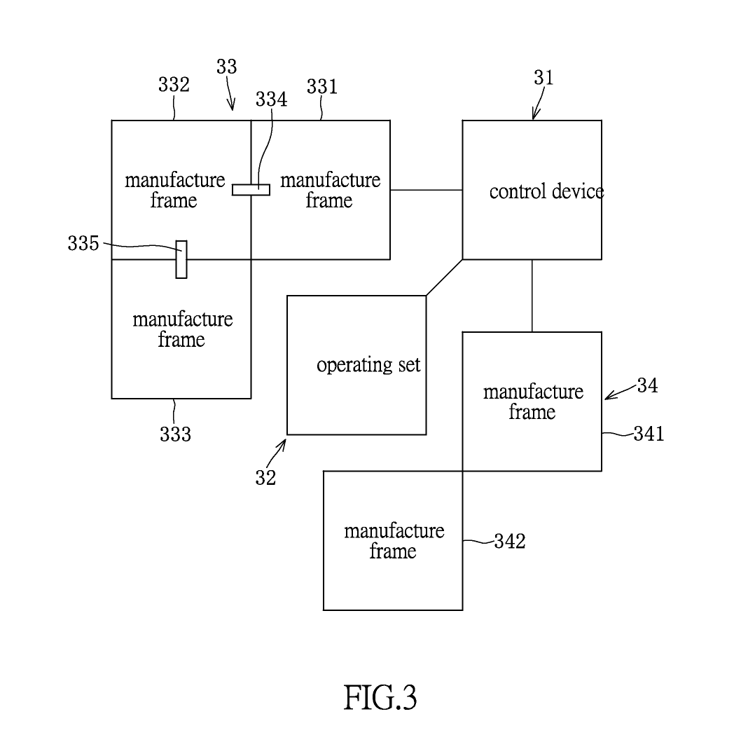

FIG. 3 schematically shows another embodiment of the present invention.

The manufacturing system includes a control device 31 used to be in charge of controlling operations of every manufacture module, every manufacture frame, and every manufacture cell. The control device 31 is electrically connected with the manufacture cells 33 and 34, and used to control the production process between the cells 33 and 34. The control device is electrically connected with every manufacture frame (331, 332, 333, 341, 342), and used to control the process made in between the manufacture frames 331, 332, 333, 341, and 342. The control device is also electrically connected with every manufacture module (not shown) for controlling the module's operation.

An operating set 32 is disposed between the manufacture cells 33 and 34, and is used to transmit articles between the cells 33 and 34. Furthermore, the operating set 32 can be used for every accessible manufacture frame, e.g. manufacture frames 331, 333, 341 and 342. The other manufacture frame, e.g. the manufacture frame 332, is inaccessible to the operating set 32, and the connection elements 334 and 335 among the manufacture frames 331, 332 and 333 are therefore introduced to perform the transmission. This diagram schematically describes the connection elements 334 and 335 which are respectively linked with the manufacture frame 331 and the manufacture frame 332, and in between the manufacture frames 332 and 333. It is noted that the connection elements 334 and 335 may be configured to be an operating set such as a robot arm, transmission band, or the like.

The function modules described in the schematic diagram of the scalable manufacturing system are shown in FIG. 3. One or more manufacture cells 33 and 34 are introduced according to a production demand. The manufacture cell 33 includes the manufacture frames 331, 332 and 333, and the manufacture cell 34 includes the interconnected manufacture frames 341 and 342. The configuration may be referred to in the diagram shown in FIG. 1D. Every manufacture frame (331, 332, 333, 341, 342) includes one or more manufacture modules (not shown), in which every module performs an individual function based on the production demand. Please refer to FIG. 1C. The configuration of every manufacture module is based on the fundamental space defined by the manufacture unit, as referred to FIG. 1A. The manufacture module is composed of multiple manufacture units, such as in FIG. 1B.

It is advantageous that the functions designed into the manufacturing system are expandable even though they may meet the limitation of space when the manufacturing system is based on the space defined by the fundamental manufacture units. For example, a third party easily provides a manufacture module for the system only if the configuration of the module is in compliance with the standardized size. The third-party manufacture module is conveniently assembled in the system. In an example, a robot arm is able to be disposed into the system and its size is determined by the system.

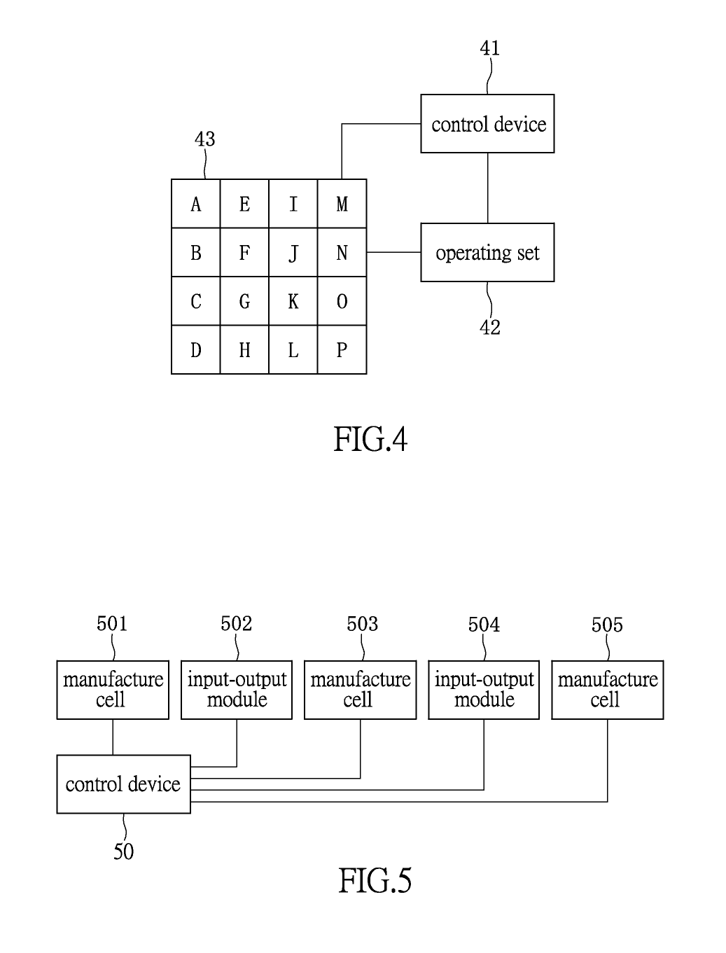

Furthermore, in FIG. 4, four-by-four manufacture modules are incorporated to a manufacture frame 43. A control device 41 is utilized to control the whole system. An operating set 42 is operated among the manufacture modules A, B, C, D, E, F, G, H, I, J, K, L, M, N, 0, and P. These manufacture modules A, B, C, D, E, F, G, H, I, J, K, L, M, N, 0, and P may be assembled to form the manufacture frame 43 by means of stacking in a vertical and/or left-to-right arrangement.

Similarly, since the shown manufacture modules A, B, C, D, E, F, G, H, I, J, K, L, M, N, O, and P are based on the standardized manufacture units, the relationship of space between the adjacent manufacture modules is definite. Therefore, in operation, the control device 41 can control the operating set 42 operating among the manufacture modules A, B, C, D, E, F, G, H, I, J, K, L, M, N, O, and P. For example, if the operating set 42 is a robot arm, the robot arm may be configured to set the movement among the modules by software means in an initial step.

Thus, the system renders the standardized space for every manufacture module, and the configuration for the robot arm can be very precise and efficient. For example, when the operating set 42 is configured to move an article from the manufacture module A to the manufacture module I, it is convenient to set the position of the operating set 42 in the manufacture module A and in the manufacture module I since the distance between the modules A and I is known. It is precisely acknowledged that the manufacture module E is in between the manufacture modules A and I. In another aspect, if an article is moved from the manufacture module F to the manufacture module P, it obviously shows this is a diagonal movement since the location of every manufacture module is predetermined.

In operation, the manufacture modules regulated by the standardized manufacture units allow the manufacturing system to incorporate multiple manufacture cells, and one or more operating sets or transportation devices are also included. In a small-sized system, the one or more operating sets or transportation devices may be disposed among the manufacture frames. Further, an input-output module may be introduced to transmit an article among the manufacture cells or manufacture frames. Reference is made to FIG. 5 schematically showing the scalable manufacturing system in one embodiment.

A control device 50 is electrically connected with every manufacture cell (501, 503, and 505) for a specific production demand. When the manufacture cell (501, 503, and 505) completes some steps in the manufacturing process, the input-output modules (502, 504) are utilized to link the cells (501, 503, and 505). The input-output modules 502 and 504 are electrically connected with the control device 50. The input-output module 502 is disposed between the manufacture cells 501 and 503. The input-output module 504 is disposed between the manufacture cells 503 and 505. The operations performed among the manufacture cells 501, 503, and 505 are controlled by the control device 50.

The production demand for the scalable manufacturing system includes multiple production steps for manufacturing a product.

Every production step may be implemented by one or more manufacture modules. Reference is made to FIG. 6 showing the circumstance when the scalable manufacturing system is required to add a function by incorporating an additional function module, in which every manufacture module is controlled by a centralized control device 60.

A testing module 601 is introduced. The testing module 601 is composed of one or more manufacture units. The testing module 601 renders a testing function in the manufacturing system. The testing module 601 may also be a manufacture frame in a production demand.

A calibration module 602 is introduced to perform calibration for the system, and calibration for the machine. The calibration module 602 may also be a manufacture frame. For example, when the calibration is performed, a reference sample is provided to compare with a product.

A welding module 603 is used to perform welding. For example, the robot arm in the module or in the frame may be utilized to perform welding.

An assembling module 604 is introduced to perform an assembly function for a specific product, for example the robot arm may accomplish the assembly.

A human station module 605 is utilized to provide space for the operator to operate any specific function or the whole system.

A tooling exchange module 606 is provided to tune the tools for the modules.

A parts supply module 607 supplies the parts for the modules.

A load-unload module 608 performs loading or unloading among the modules.

A robot operating module 609 provides the robot as demands require.

A robot station module 610 provides a robot or robot arm to conduct specific functions for the system. However, the practical operation may not be limited to the above modules in the manufacturing system of the present invention.

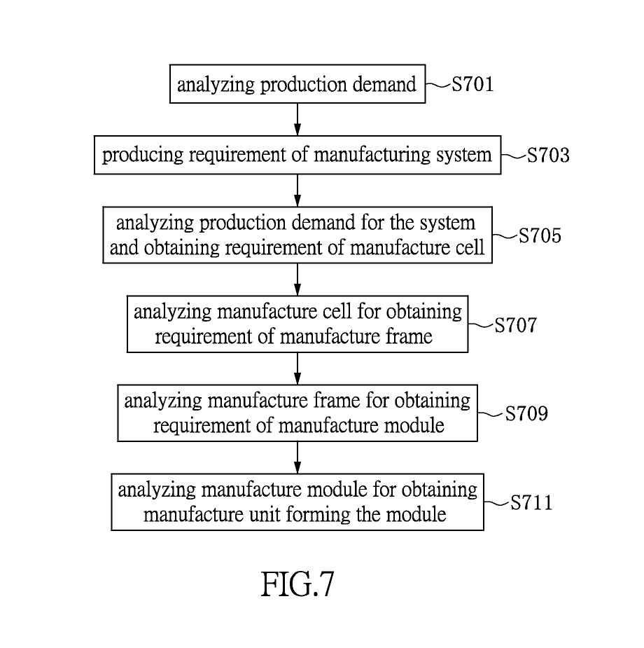

The elements forming the manufacturing system may be easily dismantled or assembled because of every portion of the system is modularized and standardized in space. When a production demand is generated, the manufacturing system is designed based on the space defined by the standardized units, in which a computer software may be utilized to simulate, test, and output a manufacturing system. FIG. 7 shows a flow chart depicting the process to come out a scalable manufacturing system.

In the method for embodying the scalable manufacturing system, in a computer system, a production demand is obtained. Through the software, the production demand is analyzed, such as in step S701. A requirement for the manufacturing system is therefore produced, e.g. the requirement of space and functions for the manufacturing process, such as in step S703.

After that, the requirement is further analyzed by the software means for obtaining the requirement of one or more manufacture cells, selectively incorporating the operating set(s) among the manufacture cells, such as in step S705. After next analyzing each of the manufacture cell(s), one or more manufacture frames required for every manufacture cell can be obtained, selectively including the operating set(s) among the manufacture frames, such as in step S707.

Continuously, the method is to analyze the manufacture frame so as to find out one or more manufacture modules required for every manufacture frame, such as in step S709. Every manufacture module conducts one of the functions required for the production demand. Last, one or more units composing the manufacture module may be obtained, such as in step S711, after analyzing the manufacture module. The manufacture module forms a fundamental function module using the spaces in compliance with the fundamental space defined by the manufacture unit module for the whole system. Because the manufacture unit defines the fundamental space, and the manufacture module conducts the fundament function for the system, the space requirement for the whole manufacturing system can be obtained. The analysis provides the knowledge to implement the whole system.

The plurality of manufacture units, manufacture modules, one or more manufacture frames, one or more manufacture cells, and/or the connection means between the different manufacture cells are disposed due to a space limitation, and every manufacture cell is connected with the control device.

Through analysis and acquiring requirements of the system, the scalable manufacturing system with flexible and function-expandable arrangement is provided.

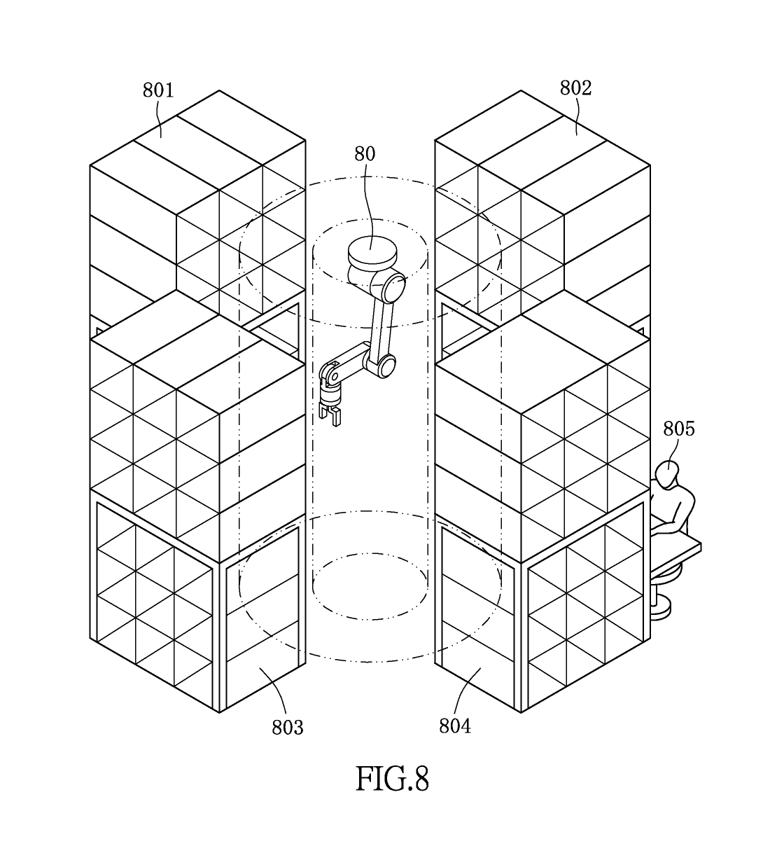

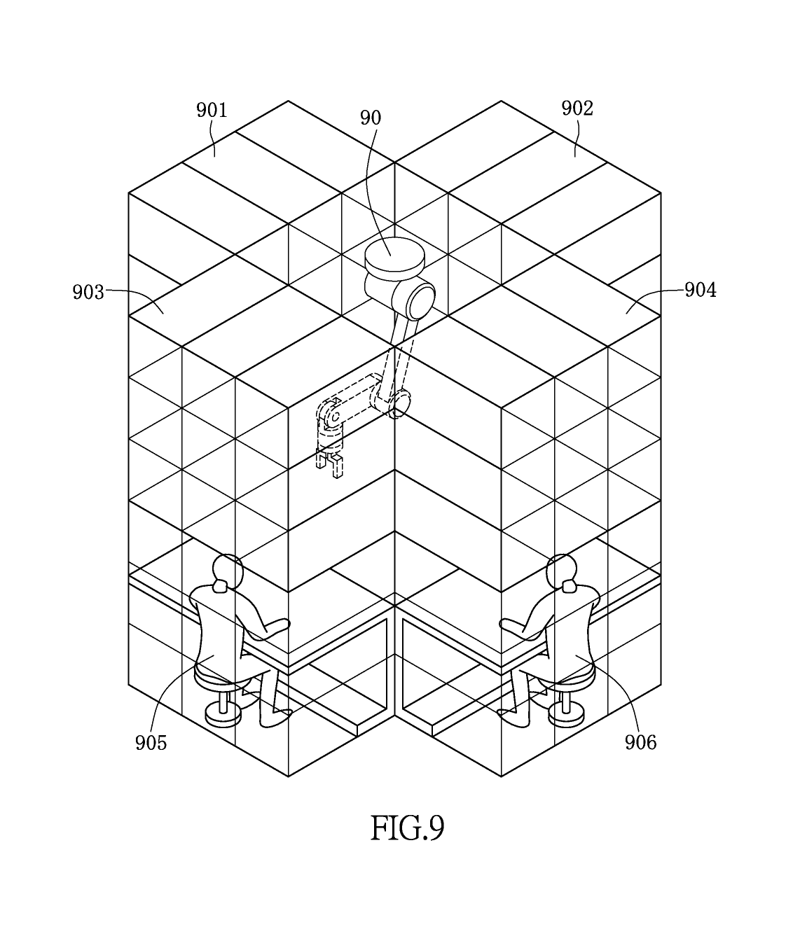

FIG. 8 through FIG. 11 respectively show various types of the scalable manufacturing systems in accordance with the present invention.

FIG. 8 again shows a schematic diagram depicting the manufacturing system composed of multiple manufacture frames 801, 802, 803, and 804, which are in charge of different manufacturing steps at different phases. The manufacture frames 801, 802, 803, and 804 define a manufacture cell. A transportation device is disposed in a central region of the system. The transportation device is such as a robot arm 80 capable of moving rotatably and vertically, and with multi-angle displacement. The robot arm 80 stays in a cylindrical operating space. At a corner of the system, a space is configured to be the place for an operator 805 to operate the system, or monitor the operation.

In FIG. 9, the manufacturing system is a close space surrounded by the manufacture frames 901, 902, 903, and 904. A robot arm 90 is provided in the central region. It is noted that the robot arm may be a device capable of moving rotatably and vertically, and with multi-angle displacement. In this example, two operating spaces for the operators 905 and 906 are provided. This operating space is such as the manufacture module or manufacture frame that is defined by the manufacture units. The three-dimensional structure for the system should be able to support the whole stacking-on system, in which the structure is fortified for supporting the tools and related equipment.

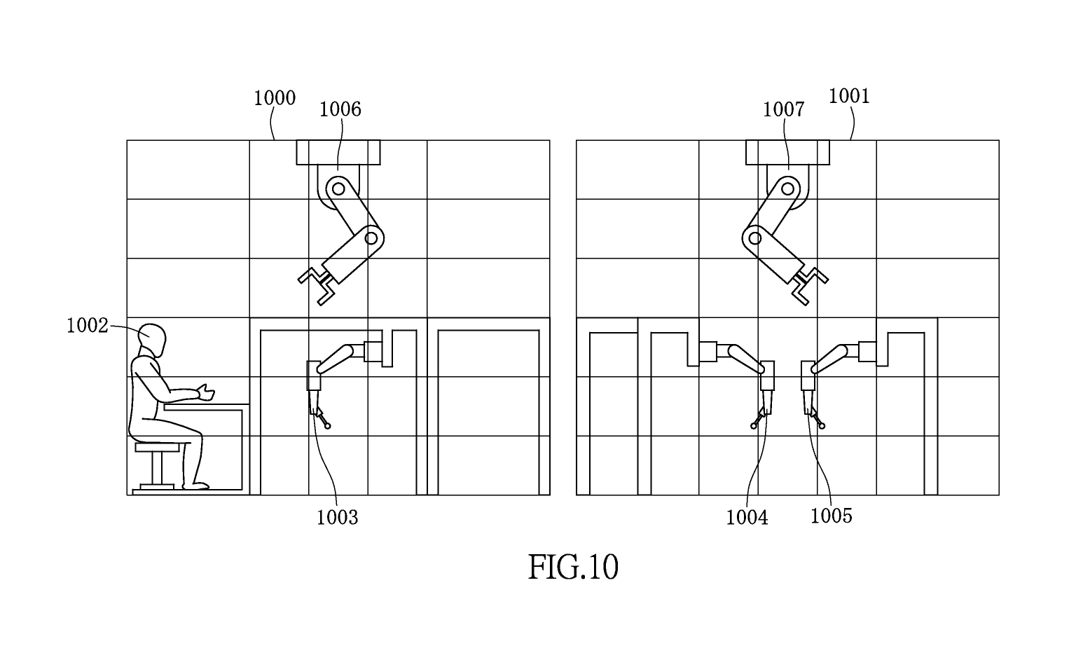

Reference is next made in FIG. 10 showing a side view of the manufacturing system in one embodiment of the present invention. In the current example, two manufacture frames 1000 and 1001 constitute a manufacture cell. The manufacture frames 1000 and 1001 may be in charge of different manufacturing steps; further, the manufacture frames 1000 and 1001 may form the manufacture cells responsible for different production lines respectively. In the schematic diagram, every frame represents one basic manufacture unit. A three-dimensional type of the manufacturing system is formed and able to be expanded to have more spaces.

The system in the diagram shows the operator 1002 staying in an operating space that is provided by a human station module 605. In the manufacture frame 1000, two operating sets 1003 and 1006 are disposed. The operating sets 1003 and 1006 act as the operating device and transportation device respectively among the manufacture modules.

A connection means is used to link the manufacture frame 1001 and the manufacture frame 1000. In the manufacture frame 1001, the operating sets 1004, 1005 and 1007 are utilized to process the various steps.

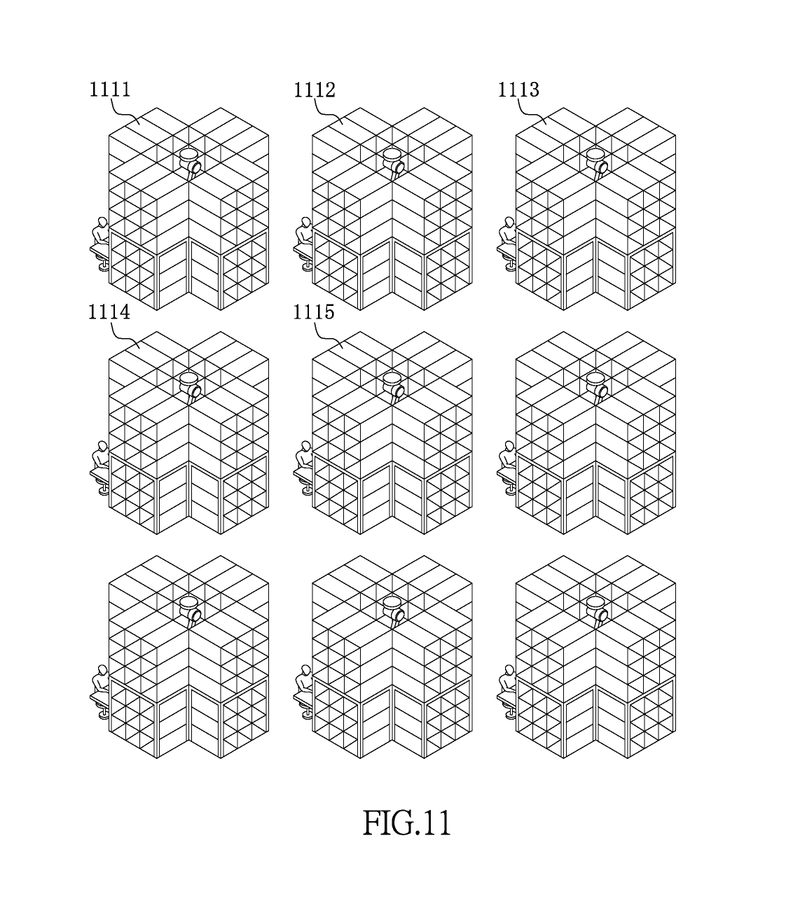

FIG. 11 schematically shows expandability of the scalable manufacturing system. In one aspect of the present invention, the manufacture cells 1111, 1112, 1113, 1114 and 1115 are linked for a specific purpose. The manufacture cells 1111, 1112, 1113, 1114, and 1115 may act in different production lines. The manufacture cells 1111, 1112, 1113, 1114, and 1115 may be configured to conduct the same steps, and the linked manufacture cells may perform the same steps for achieving mass production.

In the various exemplary examples, the robot, robot arm, transmission band, vehicle, staffs, network, or electric circuits may implement the connections among the manufacture cells 1111, 1112, 1113, 1114, and 1115. The framework of the system is scalable and replicable because all the components adapted to the system are under the standard based on the standardized units.

The above embodiments show the main features of the scalable manufacturing system are such as providing the manufacture unit with standardized size (referring to FIG. 1A) utilized to design every part of the system, and embodying the manufacturing system within a limited space through an aspect of the three-dimensional configuration of the system. Every manufacture module performs a function in the production line. Assembly of multiple manufacture modules is able to implement a full production line. Alternatively, multiple manufacture frames may also form a full production line. A transportation device such as a robot arm capable of moving rotatably and vertically, and with multi-angle displacement may be centered in the three-dimensional system and acts as the operative set among the manufacture modules, manufacture frames or the manufacture cells.

Thus, the disclosure is related to a scalable manufacturing system that is established by one or more manufacture cells. Every manufacture cell is formed by assembling one or more manufacture frames; every manufacture frame is formed by integrating multiple manufacture modules; and every manufacture module performs a specific function for the full production line and is made of multiple manufacture units. The manufacture unit defines the minimum standardized size for the whole manufacturing system and gains flexibility to form the modules in any combination according to the production demand. The transportation device in the system may travel from a flat to a three-dimensional space which not only increases the flexibility of production, but also reduces the use of space.

It is intended that the specification and depicted embodiment be considered exemplary only, with a true scope of the invention being determined by the broad meaning of the following claims.

What is claimed is:

1. A scalable manufacturing system, comprising:
one or more manufacture cells for a production demand, wherein every manufacture cell includes one or more manufacture frames; every manufacture frame includes one or more manufacture modules, and every manufacture module renders a function for the production demand; the every manufacture module is essentially composed of one or more manufacture units; wherein the one manufacture unit defines a fundamental space in the manufacturing system; and
a control device, electrically connected with every manufacture cell, used to control production process among the manufacture cells; electrically connected with every manufacture frame, used to control production process among the manufacture frames; and electrically connected with every manufacture module, used to control operation of every manufacture module.

2. The system as recited in claim 1, wherein, if the manufacturing system has a plurality of manufacture cells, one or more operating sets are disposed among the manufacture cells.

3. The system as recited in claim 2, wherein the operating set is a transportation device among the multiple manufacture frames.

4. The system as recited in claim 3, wherein the transportation device is a robot arm capable of moving rotatably and vertically, and with multi-angle displacement.

5. The system as recited in claim 4, wherein the multiple manufacture modules are assembled to form the one or more manufacture frames by means of stacking in vertically and/or in a left-to-right arrangement.

6. The system as recited in claim 1, wherein, one or more operating sets are disposed among the plurality of manufacture frames.

7. The system as recited in claim 6, wherein the operating set is a transportation device among the plurality of manufacture frames.

8. The system as recited in claim 7, wherein the transportation device is a robot arm capable of moving rotatably and vertically, and with multi-angle displacement.

9. The system as recited in claim 8, wherein the multiple manufacture modules are assembled to form the one or more manufacture frames by means of stacking vertically and/or in a left-to-right arrangement.

10. The system as recited in claim 1, wherein the multiple manufacture modules are assembled to form the one or more manufacture frames by means of stacking vertically and/or in a left-to-right arrangement.

11. The system as recited in claim 1, wherein the production demand in the manufacturing system includes multiple production steps for manufacturing a product, and every production step is implemented by one or more manufacture modules.

12. A method for implementing the scalable manufacturing system as recited in claim 1, comprising:
in a computer system, obtaining a production demand for the manufacturing system, and analyzing the production demand;
producing a requirement for the manufacturing system;
analyzing the requirement for the manufacturing system, so as to obtain the requirements of one or more manufacture cells;
analyzing every manufacture cell for obtaining the requirement of one or more manufacture frames, and the one or more manufacture frames forms the manufacture cell;
analyzing every manufacture frame for obtaining the requirement of one or more manufacture modules, wherein the one or more manufacture modules form the manufacture frame, and every manufacture module renders one function for the production demand; and
analyzing every manufacture module for obtaining one or more manufacture units, wherein the manufacture unit defines a fundamental space for the manufacturing system.

13. The method as recited in claim 12, wherein, if the manufacturing system includes multiple manufacture cells, one or more operating sets are required among the multiple manufacture cells based on the production demand analysis.

14. The method as recited in claim 13, wherein the operating set is a transportation device among the plurality of manufacture cells.

15. The method as recited in claim 14, wherein the transportation device is a robot arm capable of moving rotatably and vertically, and with multi-angle displacement.

16. The method as recited in claim 12, wherein the multiple manufacture modules are assembled to form the one or more manufacture frames by means of stacking vertically and/or in a left-to-right arrangement.

17. The method as recited in claim 12, wherein, one or more operating sets are required among the multiple manufacture frames based on the production demand analysis.

18. The method as recited in claim 12, wherein the production demand includes production steps for manufacturing a product, and every production step is performed by the one or more manufacture modules.
